(19) United States
(12) Patent Application Publication
(10) Pub. No.: US 2015/0158205 A1
(43) Pub. Date: Jun. 11, 2015

(54) POROUS BODY AND METHOD FOR PRODUCING SAME

(71) Applicants: Shuji Sotozaki, Okazaki-shi (JP); Yuichi Furukawa, Toyota-shi (JP)

(72) Inventors: Shuji Sotozaki, Okazaki-shi (JP); Yuichi Furukawa, Toyota-shi (JP)

(73) Assignee: TOYOTA JIDOSHA KABUSHIKI KAISHA, Aichi (JP)

(21) Appl. No.: 14/355,426

(22) PCT Filed: Nov. 4, 2011
(86) PCT No.: PCT/JP2011/075510

§ 371 Date: Apr. 30, 2014

(51) Int. Cl. B29C 33/38

(52) U.S. Cl. CPC B29C 33/3814; B29K 2907/04; B29L 2031/757

(57) ABSTRACT

Disclosed are a porous body with high strength, and a method for producing the porous body. Specifically disclosed is a porous body, which includes a carbon foam which is a porous material consisting primarily of carbon, and a carbon film which is formed on the surface of the carbon foam. The carbon film has a plurality of microscopic carbon fibers which are fibrous nanocarbons such as carbon nanofibers, carbon nanotubes, carbon nanocoils or carbon nanofilaments, and a plurality of fullerenes which are substantially spherical nanocarbons each consisting of a plurality of carbon atoms.

### TECHNICAL FIELD

The present invention relates to a porous body and a method for producing the porous body.

### BACKGROUND ART

Conventionally, a porous body is used as a casting mold, a separator of a battery or the like.

Patent Literature 1 discloses a mold (metal mold) in which the porous body (porous material) made from metal powders such as stainless steel powders is used as a part of a cavity.

The mold disclosed in Patent Literature 1 makes it possible to discharge a gas from the cavity through pores of the porous body, and consequently to suitably perform molding without the gas remaining in molten metal.

However, the mold disclosed in Patent Literature 1 has strength lower than that of a conventional mold owing to a structure of the porous body having a large number of pores. For example, the mold expands and contracts by heat of the molten metal during the molding, which may cause the mold to crack.

Moreover, even in a battery, a separator made of the porous body may be damaged by heat, shock and the like. Therefore, increasing strength of the separator is expected.

### CITATION LIST

### Patent Literature

Patent Literature 1: JP 2005-334898 A

### SUMMARY OF INVENTION

### Problem to Be Solved By the Invention

The objective of the present invention is to provide a porous body with high strength, and a method for producing the porous body.

### Means for Solving the Problem

A first aspect of the invention is a porous body including a carbon foam which is a porous material consisting primarily of carbon, and a carbon film which is formed on a surface of the carbon foam, and which includes at least one kind of nanocarbon.

Preferably, the carbon foam acts as a mold having a molding surface, and the carbon film is formed on the molding surface.

More preferably, porosity of the carbon foam is 10 through 70%.

Even more preferably, the carbon foam contains carbon in amount of 90 wt. % or more.

A second aspect of the invention is a method for producing a porous body, including a carbon foam producing step for producing a carbon foam which is a porous material consisting primarily of carbon, and a carbon film forming step for forming a carbon film including at least one kind of nanocarbon on a surface of the carbon foam.

### Effects of the Invention

The present invention makes it possible to increase strength of a porous body.

### BRIEF DESCRIPTION OF DRAWINGS

FIG. 1 shows a porous body according to an embodiment of the present invention.

FIG. 2 shows a step for producing the porous body.

FIG. 3 shows an experiment for checking fluidity on the porous body.

FIG. 4 shows a porous body according to another embodiment of the present invention.

### DESCRIPTION OF EMBODIMENTS

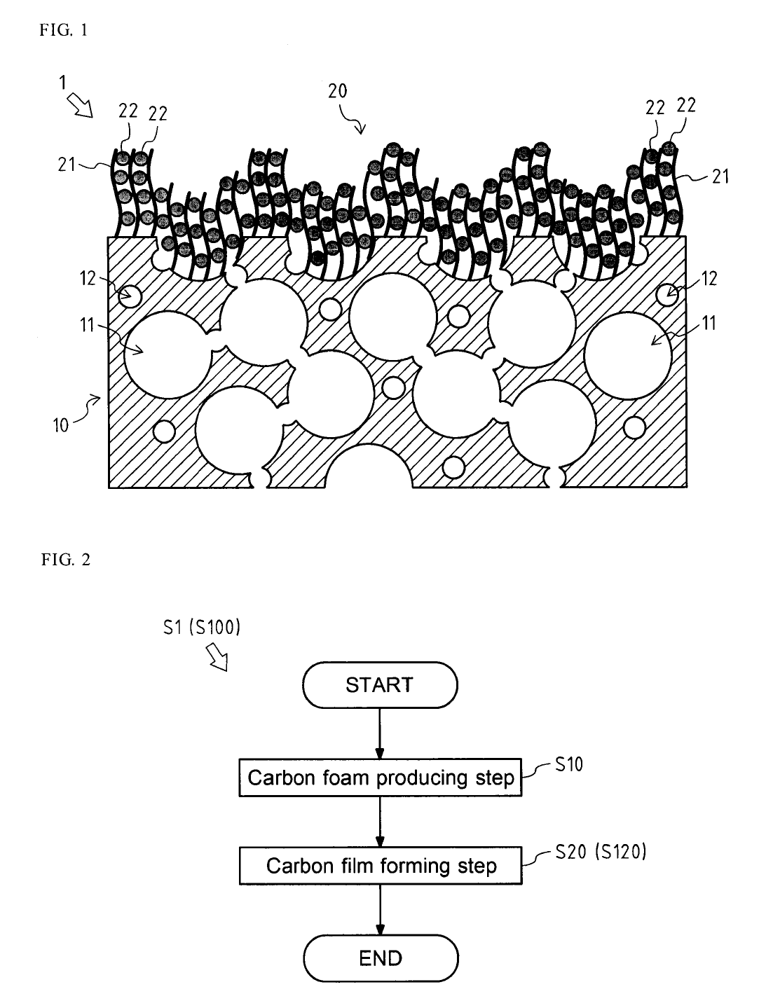

With reference to FIG. 1, described below is a porous body 1 as an embodiment of a porous body according to the present invention.

As shown in FIG. 1, the porous body 1 is a casting mold, and includes a carbon foam 10 and a carbon film 20.

The carbon foam 10 acts as a casting mold, and one surface (upper surface in FIG. 1) of the carbon foam 10 is formed as a molding surface. The carbon foam 10 is a porous material consisting primarily of carbon, which is made from pitch, coal or the like. The carbon foam 10 has a plurality of pores, and a surface of the carbon foam 10 is bumpy owing to the plurality of pores. The carbon foam 10 contains carbon in amount of 90 wt. % or more, and porosity of the carbon foam 10 is 10 through 70 %.

Note that the porosity is proportion of pores in a porous material, and is calculated on the basis of volume, real density and weight of the porous material.

A CFOAM (registered trademark) developed by Touchstone Research Laboratory, Inc. in the United States of America may be used as the carbon foam 10.

The plurality of pores present in the carbon foam 10 includes a plurality of large pores 11, and a plurality of small pores 12 each having a diameter smaller than that of the large pore 11.

The large pore 11 has a relatively large diameter of approximately 1500 μm, and the small pore 12 has a relatively small diameter of approximately 50 μm.

Several small pores 12 combine with one large pore 11, and several small pores 12 open on the surface of one large pore 11. Moreover, the plurality of large pores 11, and the plurality of small pores 12 connect a space which the molding surface (upper surface in FIG. 1) of the carbon foam 10 faces to a space on the side opposite to the molding surface of the carbon foam 10.

The carbon film 20 is a dense film for realizing decrease of mold-release resistance, and the like. The carbon film 20 is formed on the molding surface of the carbon foam 10. The carbon film 20 includes a plurality of microscopic carbon fibers 21, and a plurality of fullerenes 22.

The microscopic carbon fiber 21 is fibrous nanocarbon such as carbon nanofiber, carbon nanotube, carbon nanocoil, or carbon nanofilament. The plurality of microscopic carbon fibers 21 are upward extended (are extended toward the upper side in FIG. 1) from the molding surface of the carbon foam 10.

The fullerene 22 is a substantially spherical nanocarbon consisting of a plurality of carbon atoms, which includes a fullerene derivative to which predetermined chemical modification is applied. In the present embodiment, C₆₀ fullerene consisting of 60 carbon atoms is used as the fullerene 22. The plurality of fullerenes 22 exists among the plurality of microscopic carbon fibers 21.

As mentioned above, in the porous body 1, the carbon film 20 is formed on the molding surface of the carbon foam 10 having low strength owing to the plurality of pores, and has dense structure formed by the plurality of microscopic carbon fibers 21 which are microscopic and fibrous, and the plurality of fullerenes 22 which are microscopic and substantially spherical.

Thus, the molding surface of the carbon foam 10 is reinforced with the dense carbon film 20, which makes it possible to suppress that the carbon foam 10 cracks by heat of the molten metal. Therefore, it is possible to increase strength of the porous body 1.

Moreover, the carbon film 20 makes the rough (bumpy) molding surface of the carbon foam 10 dense, which makes it possible to realize satisfactory fluidity.

Since the carbon foam 10 consists primarily of carbon, the carbon foam 10 is easy to combine with the carbon film 20 which similarly consists primarily of carbon.

Therefore, in the porous body 1, it is possible to suppress that the carbon film 20 is peeled off from the carbon foam 10.

Moreover, since the carbon foam 10 consists primarily of carbon, the carbon foam 10 has thermal conductivity lower than that of a metal which is generally used for a metal mold, and also has low affinity for the molten metal (e.g. aluminum alloy).

Therefore, in the porous body 1, it is possible to realize satisfactory fluidity.

Furthermore, it is possible to reduce cost required for the molding without applying a coating agent to the molding surface of the porous body 1.

Note that the coating agent is powder of mica or the like, and is used for improving fluidity in molding. When the coating agent dispersed in water is applied to a molding surface of a mold, the water vaporizes, and the coating agent adheres to the molding surface of the mold. During molding, the coating agent stands between the molding surface of the mold and molten metal. Therefore, heat retaining property of the mold improves, and consequently the fluidity improves. Moreover, since gas present in the molten metal flows into spaces between particles of the coating agent, the fluidity improves.

In addition to the above, in the porous body 1, it is possible to take advantage of the carbon foam 10.

Specifically, as mentioned previously, in the carbon foam 10, since the plurality of large pores 11, and the plurality of small pores 12 connect the space which the molding surface of the carbon foam 10 faces to the space on the side opposite to the molding surface of the carbon foam 10. Therefore, during the molding, gas in a cavity, gas present in the molten metal, and the like may be discharged to the outside (the space on the side opposite to the molding surface of the carbon foam 10).

This makes it possible to reduce the cost required for the molding without providing the porous body 1 with a venting structure for discharging the gas in the cavity, the gas present in the molten metal, and the like to the outside.

Moreover, since the carbon foam 10 has the plurality of pores, the carbon foam 10 thermally expands less than a material which does not have the plurality of pores during the molding.

This makes it possible to minimize distortion of the porous body 1 during the molding, and consequently to improve quality of a casting to be produced.

Moreover, since the carbon foam 10 has the plurality of pores, the carbon foam 10 is lighter than a material (e.g. die steel) which is generally used for a mold.

This makes it possible to lighten the porous body 1. In particular, since the carbon foam 10 consists primarily of carbon, it is possible to further lighten the porous body 1.

With reference to FIG. 2, described below is a step S1 for producing the porous body 1 as an embodiment of a method for producing a porous body according to the present invention.

As shown in FIG. 2, the step S1 includes a carbon foam producing step S10 and a carbon film forming step S20.

The carbon foam producing step S10 is a step for producing the carbon foam 10.

In the carbon foam producing step S10, a porous material is produced by foaming pitch, coal or the like, and then the carbon foam 10 is produced by forming the porous material in a predetermined shape (shape of a mold).

It is preferable that the carbon foam 10 contains carbon in amount of 90 wt. % or more.

This is because the carbon foam 10 and the carbon film 20 are suitably combined with each other.

Moreover, it is preferable that the porosity of the carbon foam 10 is 10 through 70%.

This is because if the porosity of the carbon foam 10 is under 10%, it is difficult to lighten the carbon foam 10, and to discharge the gas through the plurality of pores. In addition, this is because if the porosity of the carbon foam 10 is over 70%, the carbon foam 10 has insufficient strength.

In the carbon foam producing step S10, the carbon foam 10 may be made of the above-mentioned CFOAM (registered trademark).

The carbon film forming step S20 is a step for forming the carbon film 20 on the molding surface of the carbon foam 10 produced in the carbon foam producing step S10.

In the carbon film forming step S20, first, the plurality of microscopic carbon fibers 21 are formed on the molding surface of the carbon foam 10 by heating the carbon foam 10 under an atmosphere of inert gas such as nitrogen in an atmosphere furnace while supplying reactive gas such as acetylene gas to the inside of the atmosphere furnace.

Next, the plurality of fullerenes 22 are applied to the plurality of microscopic carbon fibers 21 formed on the molding surface of the carbon foam 10. When or after the plurality of fullerenes 22 are applied thereto, the plurality of microscopic carbon fibers 21 and the plurality of fullerenes 22 may quickly be combined with each other by suitably heating the plurality of microscopic carbon fibers 21 and the plurality of fullerenes 22 by means of ohmic heating or the like.

Thus, the carbon film 20 is formed on the molding surface of the carbon foam 10.

As mentioned above, in the step S1, the porous body 1 is produced by performing the carbon foam producing step S10 and the carbon film forming step S20 in this order.

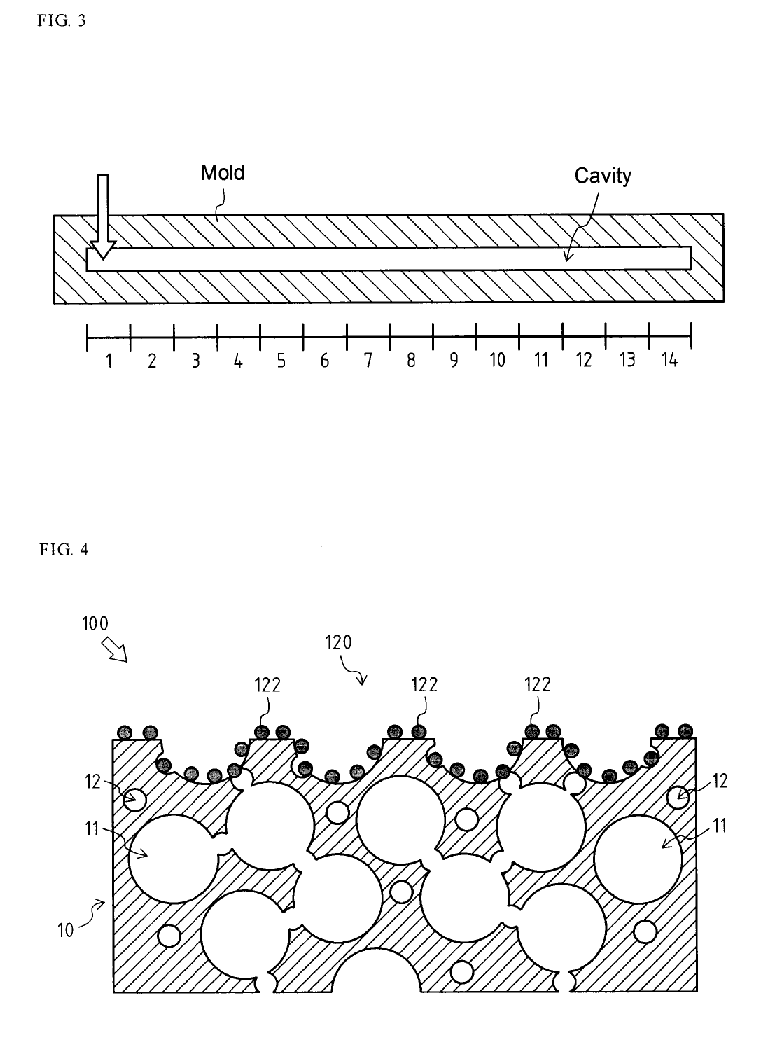

With reference to FIG. 3, characteristics of the porous body 1 are described below.

For convenience, a right-left direction in FIG. 3 is referred to as simply a right-left direction. The right-left direction is parallel to a horizontal plane.

As shown in FIG. 3, three molds each of which has a cavity extending in the right-left direction were produced on different conditions, and an experiment for checking the fluidity on the porous body 1 was performed.

In the experiment, molten metal was supplied to the cavity from above the left end of the cavity of each mold (see the white-painted arrow in FIG. 3), and an amount of flow of the molten metal was measured.

The three molds had the same shapes.

The cavity of each mold was formed in substantially a rectangular cuboid, and was, for convenience, divided into 14 sections in the right-left direction. The cavity had dimension in the right-left direction of 490 mm, and the section had dimension in the right-left direction of 35 mm.

The molten metal was ADC 12 of aluminum alloy, and the temperature thereof was kept at 700° C.

### EXAMPLE

The experiment was performed using the mold having a structure similar to that of the porous body 1. A release agent was not applied to the molding surface of the mold.

In this case, the molten metal reached the right end of the cavity.

### Comparative Example 1

Die steel which was generally used for a conventional metal mold was used as a material of the mold, and a film similar to the carbon film 20 was formed on the molding surface of the mold. The release agent was not applied to the molding surface of the mold.

In this case, the molten metal reached a position beyond the 10th section from the left of the cavity.

### Comparative Example 2

The experiment was performed similarly to the comparative example 1 except that the release agent was applied to the molding surface of the mold. In this case, the molten metal reached a position beyond the 12th section from the left of the cavity.

The result of the experiment showed clearly that the fluidity on the porous body 1 was better than the fluidity on a conventional metal mold. In particular, since the fluidity on the porous body 1 was better than the fluidity on the conventional metal mold to which the release agent was applied, the fluidity on the porous body 1 was excellent.

In the present embodiment, the carbon film 20 including the plurality of microscopic carbon fibers 21 and the plurality of fullerenes 22 is formed on the molding surface of the carbon foam 10. However, a carbon film according to the present invention only needs to include at least one kind of nanocarbon.

For example, a carbon film consisting of carbon nanotubes may be used as a carbon film according to the present invention.

Moreover, as mentioned below, a carbon film 120 may be used as a carbon film according to the present invention.

With reference to FIG. 4, described below is a porous body 100 including the carbon film 120 as another embodiment of a porous body according to the present invention.

Hereinafter, the same parts of the porous body 100 as those of the porous body 1 are each indicated by the same reference sign, and a description thereof is omitted.

As shown in FIG. 4, the porous body 100 is a casting mold, and includes the carbon foam 10 and the carbon film 120.

The carbon film 120 is a dense film for realizing decrease of mold-release resistance, and the like. The carbon film 120 is formed on the molding surface of the carbon foam 10. The carbon film 120 includes a plurality of fullerenes 122.

The fullerene 122 is a substantially spherical nanocarbon consisting of a plurality of carbon atoms, which includes a fullerene derivative to which predetermined chemical modification is applied. In the present embodiment, C₆₀ fullerene consisting of 60 carbon atoms is used as the fullerene 122. The plurality of fullerenes 122 exists on the molding surface of the carbon foam 10.

Since the fullerene 122 has an outside diameter of approximately 1 nm, the fullerene 122 can enter the large pore 11 with a diameter of approximately 1500 μm, and the small pore 12 with a diameter of approximately 50 μm. Therefore, the plurality of fullerenes 122 exists on the surfaces of the plurality of large pores 11 and the surfaces of the plurality of small pores 12 in the vicinity of the molding surface of the carbon foam 10.

This makes it possible to suppress that the plurality of fullerenes 122 existing on the surfaces of the plurality of large pores 11 and the surfaces of the plurality of small pores 12 are removed from the carbon foam 10, and consequently to suppress that the carbon film 120 is peeled off from the carbon foam 10.

As mentioned above, in the porous body 100, the dense carbon film 120 is formed on the molding surface of the carbon foam 10 having low strength owing to the plurality of pores.

Thus, the molding surface of the carbon foam 10 is reinforced with the dense carbon film 120, which makes it possible to suppress that the carbon foam 10 cracks by heat of the molten metal. Therefore, it is possible to increase strength of the porous body 100.

Moreover, the carbon film 120 makes the rough (bumpy) molding surface of the carbon foam 10 dense, which makes it possible to realize satisfactory fluidity.

Since the carbon foam 10 consists primarily of carbon, the carbon foam 10 is easy to combine with the carbon film 120 which similarly consists primarily of carbon.

Therefore, in the porous body 100, it is possible to suppress that the carbon film 120 is peeled off from the carbon foam 10.

Moreover, since the carbon foam 10 consists primarily of carbon, the carbon foam 10 has thermal conductivity lower than that of a metal which is generally used for a metal mold, and also has low affinity for the molten metal (e.g. aluminum alloy).

Therefore, in the porous body 100, it is possible to realize satisfactory fluidity.

Furthermore, it is possible to reduce cost required for the molding without applying the coating agent to the molding surface of the porous body 100.

In addition to the above, in the porous body 100, it is possible to take advantage of the carbon foam 10 as mentioned previously.

With reference to FIG. 2, described below is a step S100 for producing the porous body 100 as another embodiment of a method for producing a porous body according to the present invention.

As shown in FIG. 2, the step S100 includes the carbon foam producing step S10 and a carbon film forming step S120.

The carbon film forming step S120 is a step for forming the carbon film 120 on the molding surface of the carbon foam 10 produced in the carbon foam producing step S10.

In the carbon film forming step S120, first, the plurality of fullerenes 122 are applied to the molding surface of the carbon foam 10.

Next, the carbon foam 10 is heated to a temperature of 400° C. or more (e.g. 500° C.) by means of ohmic heating or the like.

Thus, the carbon foam 10 is combined with the plurality of fullerenes 122, and the carbon film 120 is formed on the molding surface of the carbon foam 10.

At this time, since the carbon foam 10 consists primarily of carbon, some of the plurality of fullerenes 122 in the carbon film 120 does not diffuse into the carbon foam 10. In the case of forming the carbon film 120 on the molding surface of a conventional metal mold, some of the plurality of fullerenes 122 in the carbon film 120 diffuses into the metal mold, and thereby the carbon film 120 cannot be made firm. However, the porous body 100 has the firm carbon film 120.

The porous body according to the present invention may be applied to not only a casting mold but also various articles such as a separator of a battery, and filter.

### INDUSTRIAL APPLICABILITY

The present invention is applied to a porous body, and to a method for producing the porous body.

### REFERENCE SIGNS LIST

1: porous body
10: carbon foam
11: large pore
12: small pore
20: carbon film
21: microscopic carbon fiber
22: fullerene

1-5. (canceled)

6. A porous body comprising:
a carbon foam which acts as a mold having a molding surface, and which is a porous material consisting primarily of carbon; and
a carbon film which is formed on the molding surface of the carbon foam, and which includes at least one kind of nanocarbon.

7. The porous body according to claim 6,
wherein porosity of the carbon foam is 10 through 70%.

8. The porous body according to claim 6,
wherein the carbon foam contains carbon in amount of 90 wt. % or more.

9. A method for producing a porous body, comprising:
a carbon foam producing step for producing a carbon foam which acts as a mold having a molding surface, and which is a porous material consisting primarily of carbon; and
a carbon film forming step for forming a carbon film including at least one kind of nanocarbon on the molding surface of the carbon foam.
